(19) United States
(12) Patent Application Publication
(10) Pub. No.: US 2013/0273408 A1
(43) Pub. Date: Oct. 17, 2013

(54) SEPARATOR FOR NON-AQUEOUS ELECTROLYTE BATTERY, AND NON-AQUEOUS ELECTROLYTE BATTERY

(71) Applicants: Takashi Yoshitomi, Iwakuni-shi (JP); Satoshi Nishikawa, Iwakuni-shi (JP); Takahiro Daidou, Iwakuni-shi (JP)

(72) Inventors: Takashi Yoshitomi, Iwakuni-shi (JP); Satoshi Nishikawa, Iwakuni-shi (JP); Takahiro Daidou, Iwakuni-shi (JP)

(73) Assignee: TEIJIN LIMITED, Osaka-shi, Osaka (JP)

(21) Appl. No.: 13/994,468

(22) PCT Filed: Dec. 12, 2011
(86) PCT No.: PCT/JP2011/078723

§ 371 Date: Jun. 14, 2013

(30) Foreign Application Priority Data
Dec. 17, 2010 (JP) 2010-282016

(51) Int. Cl. H01M 2/16

(52) U.S. Cl. CPC H01M 2/1686
USPC 429/144

(57) ABSTRACT

The present invention provides a separator for a non-aqueous electrolyte battery that includes a porous base material including a polyolefin and a heat-resistant porous layer provided on at least one surface of the porous base material and including a heat-resistant resin, in which when a thermomechanical analysis measurement has been performed by applying a constant load, the separator for a non-aqueous electrolyte battery satisfies the following conditions (i) and (ii):
(i) at least one shrinkage peak appears in a temperature range of from 130 to 155° C. in a displacement waveform representing shrinkage displacement with respect to temperature; and
(ii) an extension rate in a range from a shrinkage peak appearance temperature T¹ to (T¹+20)° C. is less than 0.5%/° C.

### TECHNICAL FIELD

The present invention relates to a separator for a non-aqueous electrolyte battery and a non-aqueous electrolyte battery.

### BACKGROUND ART

Non-aqueous electrolyte batteries, particularly, non-aqueous secondary batteries represented by lithium-ion secondary batteries have high energy density and thus are broadly used as a main power source for mobile electronic devices such as mobile phones and notebook personal computers. While the lithium-ion secondary batteries are expected to have higher energy densities, it is a technical problem how to ensure battery safety.

To ensure the safety of lithium-ion secondary battery, a separator has an important role. Especially, from the viewpoint of providing a shutdown function to the separator, conventional separators use a porous membrane of polyolefin, particularly polyethylene. Here, the shutdown function means a function in which an increase in battery temperature causes the micropores of a porous membrane to close so that electric current is shut down. The function is useful as a mechanism for avoiding thermal runaway of batteries.

However, a working principle of the shutdown function is the closing of micropores due to melting of a porous membrane made of polyethylene or the like, which is not necessarily compatible with heat resistance or the like. That is, after the shutdown function has worked, if battery temperature further increases, the melting of the separator (a so-called meltdown) proceeds and short circuit can occur inside the battery. Along with the short circuit, a large amount of heat is generated, which can lead to a risk such as fuming, ignition, or explosion. Accordingly, in addition to having the shutdown function, the separator needs to be free from short circuit even if battery temperature is beyond a temperature at which the shutdown function acts. In other words, the separator is desired to have heat resistance that suppresses the risk of short circuit even when battery is kept for a certain length of time at a higher temperature than the shutdown temperature.

Under such circumstances, conventional techniques are known in which on a surface of a polyolefin microporous membrane is formed a heat-resistant porous layer including a heat-resistant resin such as an aromatic polyamide (see Patent Document 1 to 4). Such a structure is thought to be excellent in that both the shutdown function and the heat resistance can be achieved.

### PRIOR ART DOCUMENT

### Patent Document

[Patent Document 1] International Publication Pamphlet WO 2008/62727
[Patent Document 2] International Publication Pamphlet WO 2008/156033
[Patent Document 3] International Publication Pamphlet WO 2008/149895
[Patent Document 4] International Publication Pamphlet WO 2010/21248

### DISCLOSURE OF THE INVENTION

### Problem to be Solved by the Invention

However, even in the conventional structure as shown in Patent Document 1 and 2, if battery is kept at a higher temperature after the shutdown function has worked, the heat-resistant porous layer cannot be maintained without any deformation under the high temperature, which may cause the entire separator to shrink. In such a case, short circuit cannot be prevented.

In addition, the inventions described in Patent Document 3 and 4 also are formed by providing a heat-resistant porous layer on a surface of a polyolefin microporous membrane but do not necessarily consider prevention of short circuit after shutdown.

Also, about the shutdown function, if the action of shutdown does not occur at an appropriate temperature, short circuit cannot still be prevented.

The present invention has been accomplished in view of the above situation. Under such circumstances,

A separator for a non-aqueous electrolyte battery is needed that has excellent shutdown function and heat resistance, hardly causes short circuit even when exposed to higher temperature environment than shutdown temperature. In addition, a non-aqueous electrolyte battery is needed that has high safety and that is formed to suppress thermal runaway, ignition, and the like under high temperature.

### Means for Solving the Problems

Specific means for achieving the objects are as follows:

A first present invention is a separator for a non-aqueous electrolyte battery that includes a porous base material including a polyolefin and a heat-resistant porous layer provided on at least one surface of the porous base material and including a heat-resistant resin, in which when a thermomechanical analysis measurement has been performed by applying a constant load and increasing temperature at a rate of 10° C./min, the separator for a non-aqueous electrolyte battery satisfies the following conditions (i) and (ii):

(i) A least one shrinkage peak appears in a temperature range of from 130 to 155° C. in a displacement waveform representing shrinkage displacement with respect to temperature; and

(ii) An extension rate in a range of from a shrinkage peak appearance temperature T¹ to (T¹+20)° C. is less than 0.5%/° C.

A second present invention is a non-aqueous electrolyte battery including a positive electrode, a negative electrode, and the separator for a non-aqueous electrolyte battery of the first present invention arranged between the positive electrode and the negative electrode, the non-aqueous electrolyte battery obtaining electromotive force by doping and dedoping of lithium.

### EFFECTS OF THE INVENTION

The present invention provides a separator for a non-aqueous electrolyte battery having excellent shutdown function and heat resistance and hardly causing short circuit even when exposed to higher temperature environment than shutdown temperature. In addition, the present invention provides a non-aqueous electrolyte battery that has high safety and that suppresses thermal runaway, ignition, and the like under high temperature.

### BRIEF DESCRIPTION OF DRAWINGS

FIG. 1 is a graph depicting an example of a TMA chart of a polyethylene porous base material and a separator.

### BEST MODES FOR CARRYING OUT THE INVENTION

The followings are a description of a separator for a non-aqueous electrolyte battery of the present invention and a detailed description of a non-aqueous electrolyte battery including the separator for a non-aqueous electrolyte battery.

The descriptions thereof and Examples are intended to merely exemplify the present invention and should not be construed as limiting the scope of the present invention.

[Separator for a Non-Aqueous Electrolyte Battery]

The separator for a non-aqueous electrolyte battery of the present invention includes a porous base material including a polyolefin and a heat-resistant porous layer provided on at least one surface of the porous base material and including a heat-resistant resin. In addition, when a thermomechanical analysis measurement has been performed by applying a constant load and increasing temperature at a rate of 10° C./minute, the separator for a non-aqueous electrolyte battery of the present invention is constructed to satisfy the following conditions (i) and (ii):

(i) at least one shrinkage peak appears in a temperature range of from 130 to 155° C. in a displacement waveform representing shrinkage displacement with respect to temperature.

(ii) an extension rate in a range of from a shrinkage peak appearance temperature T¹ to (T¹+20)° C. is less than 0.5%/° C.

The separator for a non-aqueous electrolyte battery of the present invention has, as described in the (i), at least one shrinkage peak in the temperature range of from 130 to 155° C. when a thermomechanical analysis measurement has been performed under a constant load (temperature increase rate: 10° C./minute) on the separator formed by combining the porous base material including a polyolefin and the heat-resistant porous layer including a heat-resistant resin. Thus, the shutdown function is actuated in the appropriate temperature range. Then, as described in the (ii), in the range of from the appearance temperature (T¹) of shrinkage peak of the separator to (T¹+20)° C., when the extension rate of the separator is less than 0.5%/° C., even under higher temperature after the actuation of the shutdown function, the heat-resistant porous layer is retained in a state of being hardly deformed, so that the shape of the separator is maintained. Therefore, membrane breakage hardly occurs in the separator when retained at high temperature, showing excellent short circuit resistance.

As described above, while setting the shutdown function at a predetermined temperature, extension is suppressed down to a slow extension, which is less than 0.5%/° C., in the temperature range of from the temperature T¹ representing shrinkage peak to a temperature T² by 20° C. higher than the temperature T¹, which is [=(T¹+20)° C.], whereby membrane breakage does not easily occur and thus, short circuit characteristics are excellent.

Here, in the present invention, thermomechanical analysis (TMA, hereinafter may be abbreviated as “TMA”) is a technique for measuring deformation (a negative displacement [μm] corresponding to shrinkage in the present invention) with respect to temperature while applying a constant load to a sample. Examples of a method for applying the load include compression, tension, bending, and the like. Specifically, the TMA uses a separator having a width of approximately 4 mm and a length of 12.5 mm as a sample, in which measurement temperature ranges from near 30° C. to 250° C., temperature increase rate is set to 10° C./minute, and a constant load of 0.02 newtons is applied. Specifically, a thermomechanical analyzer TMA 2940 V2.4E manufactured by TA Instruments Co., Ltd is used to perform measurement under the above conditions.

Herein, shrinkage peak represents an amount of displacement appearing on a curve obtained by plotting temperature on one axis (for example, the horizontal axis) and the amount of shrinkage (the amount of displacement) of separator on the other axis (for example, the vertical axis). That is, in the above curve, when displacement in a non-shrunken state is defined as 0 (zero) in a displacement waveform representing the displacement of amount of shrinkage with respect to temperature change, shrinkage peak represents an amount of displacement (the top point of a convex waveform indicates a maximum displacement point) appearing in a convex shape on the minus side (which indicates shrinkage).

Additionally, extension rate represents a value (unit: %/° C.) by dividing an amount (%) of displacement observed when a sample has extended in the range of from a shrinkage peak temperature T¹ to a temperature by 20° C. higher than the temperature T¹[=(T¹+20)° C.] by 20 [° C.]. The region of from an appearance temperature of absorption peak of the composite separator to a temperature by 20° C. higher than the temperature is a temperature range requiring minimum shape retention. Until the temperature, the shape of the separator is retained.

In the present invention, the porous base material may have one or two or more shrinkage peaks in a range of preferably from 100 to 160° C. It is only necessary that on one surface or both surfaces of the porous base material is provided (for example, coated) the heat-resistant porous layer and eventually the shrinkage peak of the separator results in one shrinkage peak in the range of from 130 to 155° C. In addition, still any other peak may be present in temperatures of 155° C. or higher.

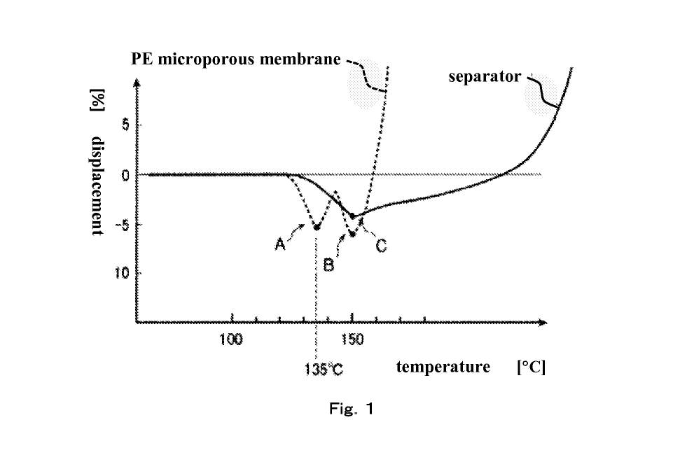

For example, as depicted in FIG. 1, the following shrinkage peaks A and B may be present. That is, in the case of the composite separator having a polyethylene porous membrane (PE membrane) and a heat-resistant porous layer including aramid or the like, a lamellar crystal occurs in the PE membrane at some point exceeding 100° C. to cause shrinkage, and a first shrinkage peak A appears near 135° C. After that, due to increased temperature, the shrink is temporarily recovered. When the temperature further increases, a so-called extended-chain crystal occurs in which the molecules have been aligned in a lengthwise direction thereof and a second shrinkage peak B appears near 150° C. In this case, in the composite separator, a single shrinkage peak C appears near 150° C. In a high temperature region of from around 150° C. to around 250° C., extension per 1° C. increase is a slow extension of less than 0.5%.

As described above, the separator for a non-aqueous electrolyte battery of the present invention has properties in which safety mechanism is provided by setting the shutdown function to a predetermined temperature, as well as membrane breakage hardly occurs since the extension rate of the separator shows the slow extension rate of 0.5%/° C. in the temperature range of from the temperature T¹ representing shrinkage peak to a temperature T² by 20° C. higher than the temperature T¹[=(T¹+20)° C.]. Therefore, the separator for a non-aqueous electrolyte battery of the present invention has excellent short circuit characteristics.

The appearance of at least one shrinkage peak in the range of from 130 to 155° C. means that the separator has the shutdown function in the above temperature range. In other words, the presence of the shrinkage peak in the range of 130° C. or higher allows the shutdown function to effectively work, and additionally, the presence of the shrinkage peak in the range of 155° C. or lower allows the shutdown speed to be favorably maintained so that short circuit is prevented.

A control method for obtaining such characteristics as the above (i) and (ii) is not particularly limited but examples of the control method include the followings: For example,

(a) a method controlling the crystallinity of the polyolefin by thermally treating (for example, a temperature of from 50 to 80° C.) the porous base material before forming the heat-resistant porous layer;

(b) a method controlling the crystallinities of the heat-resistant resin and the polyolefin by thermally treating (for example, a temperature of from 50 to 80° C.) the separator in the state in which the heat-resistant porous layer has been formed on the porous base material; and

(c) a method controlling the thickness and the porosity of the heat-resistant porous layer.

In the thermal treatment, after heating the porous base material at a temperature of from 50 to 80° C., the resulting porous base material and the heat-resistant porous layer may be stacked together to form a separator. Alternatively, after coating the heat-resistant porous layer onto the porous base material, heating may be performed at the temperature of from 50 to 80° C. In addition, the thermal treatment can be performed by allowing a long-shaped product to be contacted with a heating roll while being conveyed. At this time, the product may be laid across in a tensioned state.

In addition, in the present invention, a shrinkage displacement amount (%: a ratio of a shrinkage length to a sample length in a non-shrunken state) of shrinkage peak of the separator is preferably from 1 to 10% from the viewpoint of the shutdown function and the short circuit resistance. When the shrinkage displacement amount of the shrinkage peak of the separator is 1% or more, the shutdown function can be easily actuated. In addition, a shrinkage displacement amount of 10% or less allows the shrinkage of the entire separator to be suppressed, which provides an excellent short circuit prevention effect under high temperature after shutdown.

Among the above range, the shrinkage displacement amount is preferably in a range of from 2 to 9%.

In the present invention, the extension rate is 0.5%/° C. or less, and more preferably 0.3%/° C. or less since the slow extension rate allows the separator to be harder to be broken.

The porous base material of the present invention preferably has at least two shrinkage peaks in the temperature range of from 130 to 155° C. Since the porous base material has two shrinkage peaks, shutdown characteristics become significantly favorable. In addition, the shrinkage peaks of the porous base material are integrated into a single shrinkage peak by forming the heat-resistant porous layer on one side or both sides of the porous base material, as depicted by a solid line in FIG. 1.

In this case, in the separator, preferably, the porous base material has plural shrinkage peaks, and an extension rate of the separator in a range of from an appearance temperature of a shrinkage peak of the plural shrinkage peaks, which is the lowest appearance temperature, to 200° C. is 0.5%/° C. or less. With such a constitution, the shape of the separator hardly changes until 200° C., so that short circuit can be prevented even under higher temperature.

A method for controlling the shrinkage peaks of the porous base material as described above is not particularly limited, but examples of the method include: for example, (1) a method producing the porous base material by selecting two kinds of polyolefins having different melting points (for example, two kinds thereof: polyethylene and polypropylene) and (2) a method controlling the crystallinity by changing stretching conditions and thermal treatment conditions in the production of the porous base material.

In addition, the separator for a non-aqueous electrolyte battery of the present invention described above can satisfy the following conditions (i) to (iii) according to differential scanning calorimetry (DSC):

(i) in a measurement waveform of the differential scanning calorimetry, the separator has a first crystal melting peak in a range of from 130° C. to less than 138° C. and has a second crystal melting peak in a range of from 139° C. to less than 150° C.;

(ii) a ratio (H²/H¹) of a crystal melting enthalpy H² of the second crystal melting peak to a crystal melting enthalpy H¹ of the first crystal melting peak is from 0.2 to 0.8; and

(iii) crystal melting enthalpy is from 100 J/g to 250 J/g.

By satisfying the above conditions according to the differential scanning calorimetry, the heat-resistant porous layer can be retained in a non-deformed state while having the shutdown function, thereby maintaining the shape of the separator. Accordingly, when the separator has been kept at high temperature, membrane breakage hardly occurs, which thus shows excellent short circuit resistance. In addition, since the porous pore size has high uniformity, excellent dimensional stability is exhibited when heated.

The crystal melting enthalpy is a value obtained by DSC measurement and specifically measured using a DSC analyzer TA-2920 manufactured by TA Instruments Co., Ltd. Herein, the first crystal melting peak (peak 1) and the second crystal melting peak (peak 2) represent displacement amounts appearing as convex waveforms in a temperature increase process in a measurement waveform according to DSC (the top point of a convex waveform indicates a maximum displacement point). In addition, a mass (g) in a crystal melting enthalpy of the separator represents the mass of the entire separator.

The shutdown temperature of the separator for a non-aqueous electrolyte battery of the present invention is preferably from 120 to 155° C. When the shutdown temperature is 120° C. or higher, high temperature preservation characteristics of a battery are favorable. And, when the shutdown temperature is 155° C. or lower, safety function is expectable when various materials of the battery have been exposed to high temperature. The shutdown temperature is preferably from 125 to 150° C.

The shutdown temperature above means the following temperature. That is,

a separator impregnated with an electrolyte prepared by adding a mixed solvent of propylene carbonate (PC)/ethylene carbonate (EC) (PC/EC=1/1 [mass ratio]) to 1M LiBF₄ is arranged between two SUS plates to form an simple cell, and then, a temperature of the cell is increased at a temperature increase rate of 1.6° C./minute and simultaneously a resistance of the cell is measured by an alternating current impedance method (amplitude: 10 mV, frequency: 100 kHz), in which the shutdown temperature means a temperature at which the resistance value has become 10³ ohm-cm² or more.

A total thickness of the heat-resistant porous layer is preferably from 30 to 100% based on the thickness of the porous base material. By setting the total thickness of the heat-resistant porous layer in the not-too-thin range of 30% or more, improvement in short circuit resistance is more effectively achieved. Additionally, by setting the total thickness in the range of 100% or less, the resistance of the separator does not become excessively high, which is desirable in terms of battery characteristics. From the same reasons, the total thickness of the heat-resistant porous layer based on the thickness of the porous base material is preferably from 40 to 90%, and more preferably, a range of from 50 to 80% is selected.

The separator for a non-aqueous electrolyte battery of the present invention has the porous base material and a heat-resistant porous layer formed by including a heat-resistant resin and layered (preferably, coat-formed) on at least one surface of the porous base material. A membrane thickness of the entire separator thus formed is preferably 30 μm or less from the viewpoint of energy density of non-aqueous secondary battery. In the separator for a non-aqueous electrolyte battery of the present invention, the heat-resistant porous layer is provided by a coating method so that the porous layer is more closely contacted with the porous base material, whereby deformation, such as thermal shrinkage of the porous base material, can be more effectively suppressed.

The porosity of the separator for a non-aqueous electrolyte battery of the present invention is preferably from 30 to 60% from the viewpoint of permeability, mechanical strength, and handling ability. More preferably, the porosity thereof is from 40 to 55%.

The Gurley value (JIS P8117) of the separator for a non-aqueous electrolyte battery of the present invention is preferably from 100 to 500 sec/100 cc from the viewpoint of obtaining a good balance between mechanical strength and membrane resistance.

The membrane resistance of the separator for a non-aqueous electrolyte battery of the present invention is preferably from 1.5 to 10 ohm-cm² from the viewpoint of load characteristics of non-aqueous secondary battery. The penetration strength of the separator for a non-aqueous electrolyte battery of the present invention is preferably from 250 to 1,000 g. A penetration strength of 250 g or more allows excellent resistance against asperities of electrodes, impact, and the like and the prevention of the occurrence of pin holes or the like in the separator in the production of a non-aqueous electrolyte secondary battery, so that short circuit of the non-aqueous electrolyte secondary battery can be more effectively avoided.

The tensile strength of the separator for a non-aqueous electrolyte battery of the present invention is preferably 10 N or more. A tensile strength of 10 N or more is preferable in that in the production of a non-aqueous electrolyte secondary battery, the separator can be favorably wound without any damage to the separator.

A heat shrinkage ratio at 105° C. of the separator for a non-aqueous electrolyte battery of the present invention is preferably from 0.5 to 10%. A heat shrinkage ratio in the above range provides a good balance between the shape stability and shutdown characteristics of the separator for a non-aqueous electrolyte battery. More preferably, the heat shrinkage ratio is from 0.5 to 5%.

(Porous Base Material)

The separator for a non-aqueous electrolyte battery of the present invention is constituted by providing the porous base material including a polyolefin.

Examples of the porous base material include layers having porous structures of a microporous membrane form, a nonwoven fabric form, a paper form, and other three-dimensional network forms. In terms of achieving better fusion, the porous base material is preferably a microporous membrane-form layer. As used herein, the microporous membrane-form layer (hereinafter referred to as also simply “microporous membrane”) means a layer having a structure in which many micropores are present thereinside and linked to each other to allow gas or liquid to pass from one face thereof to the other face thereof.

The microporous membrane is preferably a polyolefin that is softened at 120 to 150° C. to cause blocking of porous voids so as to actuate the shutdown function and also insoluble in electrolyte of the non-aqueous electrolyte battery.

Examples of the polyolefin in the present invention include at least one polyolefin selected from polyethylenes such as low density polyethylene, high density polyethylene, and ultra high molecular weight polyethylene, polypropylenes, copolymers thereof, and the like.

In addition, the porous base material can include inorganic or organic microparticles according to need.

The porous base material is mainly composed of polyolefin. As used herein, the word “mainly” means that a percentage of polyolefin in the porous base material is 50% by mass or more, preferably 70% by mass, more preferably 90% by mass, and may be even 100% by mass.

The porous base material has a thickness of preferably from 5 to 25 μm, and more preferably from 5 to 20 μm. When the thickness of the porous base material is 5 μm or more, the shutdown function favorably works. In addition, when the thickness thereof is 25 μm or less, the thickness of the separator does not become too large in the case of a separator for a non-aqueous electrolyte battery also including a heat-resistant porous layer, allowing a range for achieving high electric capacity to be maintained.

The porous base material has a porosity of preferably from 30 to 60% from the viewpoint of permeability, mechanical strength, and handling ability. When the porosity is 30% or more, the permeability and the amount of electrolyte are appropriately retained. When the porosity is 60% or less, mechanical strength as the base material when molded into a membrane can be maintained, as well as the shutdown function is allowed to work with good responsiveness. The porosity thereof is more preferably from 40 to 55%.

The Gurley value (JIS P8117) of the porous base material is preferably from 50 to 500 sec/100 cc from the viewpoint of obtaining the good balance between mechanical strength and membrane resistance.

The membrane resistance of the porous base material is preferably from 0.5 to 8 ohm-cm² from the viewpoint of the load characteristics of non-aqueous electrolyte battery.

The penetration strength of the porous base material is preferably 250 g or more. A penetration strength of 250 g or more allows excellent resistance against asperities of electrodes, impact, and the like and the prevention of the occurrence of pin holes or the like in the separator in the production of a non-aqueous electrolyte battery. As a result, short circuit of the non-aqueous electrolyte battery can be more effectively avoided.

The tensile strength of the porous base material is preferably 10 N or more. A tensile strength of 10 N or more is preferable in that, in the production of a non-aqueous electrolyte secondary battery, the separator can be favorably wound without any damage to the separator.

˜Method for Producing Porous Base Material˜

A method for producing the porous base material described above is not particularly limited. Specifically, for example, the porous base material can be produced by a method including the following steps (1) to (6). In addition, polyolefin used as a raw material is as described above.

(1) Preparation of Polyolefin Solution

Polyolefin is dissolved in a solvent in a predetermined amount ratio to prepare a solution. At this time, the polyolefin solution may be prepared by mixing solvent. Examples of the solvent include paraffin, liquid paraffin, paraffin oil, mineral oil, castor oil, tetralin, ethylene glycol, glycerin, decalin, toluene, xylene, diethyl triamine, ethyl diamine, dimethyl sulfoxide, hexane, and the like. A concentration of polyolefin in the polyolefin solution is preferably from 1 to 35% by mass, and more preferably from 10 to 30% by mass. When the concentration of the polyolefin solution is 1% by mass or more, a gel molded product obtained by cooling gelation can be maintained so as not to highly swell due to the solvent and is therefore hard to deform, whereby good handling ability is obtained. On the other hand, when the concentration is 35% by mass or less, pressure applied when extruded is suppressed and thus an amount of discharging can be maintained, which results in excellent productivity. In addition, alignment hardly proceeds in an extrusion step, which is advantageous to ensure stretchability and uniformity.

In addition, the polyolefin solution is preferably filtered to remove foreign matter before use. The filtering device, the shape and type of filter, and the like are not particularly limited, and any conventionally known device and type can be used. In this case, a hole size (filtering diameter) of the filter is preferably from 1 to 50 μm from the viewpoint of filterability. A hole diameter of 50 μm or less allows excellent filterability, thereby achieving good efficiency in the removal of foreign matter. In addition, a hole diameter of 1 μm or more provides good filterability, so that high productivity can be maintained.

(2) Extrusion of Polyolefin Solution

The prepared solution is kneaded in a single screw extruder or a twin screw extruder and extruded from a T-die or an I-die at a temperature of a melting point or higher and the melting point plus 60° C. or lower. Preferably, a twin screw extruder is used. Then, the extruded solution is allowed to pass over a chill roll or pass through a cooling bath to form a gel composition. In this situation, preferably, the extruded solution is rapidly cooled down to a gelation temperature or lower and the solution is gelate. Particularly, when a volatile solvent and a nonvolatile solvent have been used in combination as the solvent, a cooling rate of the gel composition is preferably 30° C./minute or more from the viewpoint of controlling crystal parameters.

(3) Desolvation Treatment

Next, the solvent is removed from the gel composition. In the case of use of a volatile solvent, heating or the like in combination with a preheating may be performed to evaporate the solvent to remove from the gel composition. Additionally, in the case of a nonvolatile solvent, the solvent can be removed, for example, by squeezing out with pressure. However, the solvent does not need to be completely removed.

(4) Stretching of Gel Composition

Following the desolvation treatment, the gel composition is stretched. Here, before stretching treatment, relaxation treatment may be performed. In the stretching treatment, the gel composition is heated and biaxially stretched at a predetermined magnification by an ordinary tenter method, roll method, compressing method, or a combination of these methods. Biaxial stretching may be performed either simultaneously or sequentially. Additionally, biaxial stretching may be longitudinal multi-step stretching or three or four-step stretching.

Heating temperature for biaxial stretching is preferably in a range of from 90° C. to less than a melting point of polyolefin, and more preferably from 100 to 120° C. When the heating temperature is less than the melting point, the gel composition is hard to be dissolved, so that stretching can be favorably performed. In addition, a heating temperature of 90° C. or higher allows the gel composition to be sufficiently softened, so that membrane breakage hardly occurs during stretching and high-magnification stretching can be achieved.

In addition, although stretching magnification varies depending on the thickness of an original membrane, the composition is uniaxially stretched by at least two times or more, and preferably from four to twenty times. Particularly, from the viewpoint of controlling crystal parameters, stretching magnification is preferably from 4 to 10 times in a machine direction (MD direction), and from 6 to 15 times in a direction vertical (TD direction) to the machine direction.

After stretching, thermal immobilization may be performed according to need to provide dimensional stability against heat.

(5) Extraction and Removal of Solvent

The gel composition after having been stretched is immersed in an extraction solvent to extract the solvent. As the extraction solvent, an easily volatile compound can be used. Examples of the easily volatile compound include hydrocarbons such as pentane, hexane, heptane, cyclohexane, decalin, and tetralin, chlorinated hydrocarbons such as methylene chloride, carbon tetrachloride, and methylene chloride, a fluorinated hydrocarbon such as ethane trifluoride, ethers such as diethyl ether and dioxane, and the like. These solvents can be arbitrarily selected according to a solvent used for dissolving polyolefin composition and can be used alone or in combination. In extraction of the solvent, the solvent in the porous base material is removed to less than 1% by mass.

(6) Annealing of Microporous Membrane

The microporous membrane is thermoset by annealing. The annealing is preferably performed in a temperature region of from 80 to 150° C. from the viewpoint of heat shrinkage ratio. Furthermore, from the viewpoint of having a predetermined heat shrinkage ratio, the annealing temperature is preferably from 115 to 135° C.

(Heat-Resistant Porous Layer)

The separator for a non-aqueous electrolyte battery of the present invention is formed by including the heat-resistant porous layer provided on at least one side of the porous base material and including a heat-resistant resin. Examples of the porous base material include layers having porous structures of a microporous membrane form, a nonwoven fabric form, a paper form, and other three-dimensional network forms. In terms of achieving better heat resistance, the heat-resistant porous layer is preferably a microporous membrane-form layer. The term “microporous membrane-form layer” means a layer having a structure in which many micropores are present thereinside and linked to each other to allow gas or liquid to pass from one face thereof to the other face thereof.

As used herein, the term “heat resistance” means properties that do not cause melting, decomposition, or the like in a temperature region of less than 200° C.

—Heat-Resistant Resin—

An appropriate heat-resistant resin forming the heat-resistant porous layer is a crystalline polymer having a melting point of 200° C. or higher or a polymer having no melting point but having a decomposition temperature of 200° C. or higher. Preferable examples of the heat-resistant resin include at least one resin selected from the group consisting of wholly aromatic polyamides, polyimides, polyamide-imides, polysulfones, polyketones, polyether ketones, polyether imides, and celluloses.

The heat-resistant resin may be a homopolymer and may include some amount of a copolymer component according to an intended purpose, such as execution of flexibility. Specifically, for example, a wholly aromatic polyamide may be copolymerized, for example, with a small amount of an aliphatic component.

Furthermore, the heat-resistant resin is suitably a wholly aromatic polyamide in that the resin is insoluble in electrolyte solution and highly durable. In addition, from the viewpoint of facilitating the formation of a porous layer and having excellent oxidation-resistance and reducibility, polymeta-phenylene isophthalamide that is a meta-type wholly aromatic polyamide is more suitable.

The heat-resistant porous layer can be formed on both surfaces or one surface of the porous base material. In a preferable embodiment, the heat-resistant porous layer is formed on both front and back surfaces of the porous base material from the viewpoint of handling ability, durability, and a suppression effect of a thermal shrinkage.

In addition, to attach the heat-resistant porous layer on the base material, preferably, the heat-resistant porous layer is directly formed on the base material by a coating method. The method for the immobilization is not limited to this method, and a technique adhering a separately produced heat-resistant porous layer sheet on the base material using an adhesive or the like or a technique such as heat fusing or pressure bonding may be employed.

Regarding the thickness of the heat-resistant porous layer, when the heat-resistant porous layer is formed on both surfaces of the porous base material, a total thickness of the heat-resistant porous layer is preferably from 3 to 12 μm. Alternatively, when the heat-resistant porous layer is formed only on one surface of the porous base material, the thickness of the heat-resistant porous layer is preferably from 3 to 12 μm. The range of thickness as mentioned above is preferable also from the viewpoint of prevention effect of an electrolyte depletion.

The porosity of the heat-resistant porous layer in the present invention is preferably from 30 to 70% from the viewpoint of increasing the advantageous effects of the present invention. When the porosity of the heat-resistant porous layer is 30% or more, the resistance of the entire separator is favorable and thus excellent battery characteristics can be obtained. In addition, when the porosity of the heat-resistant porous layer is 70% or less, an excellent effect of suppressing membrane breakage of the porous base material can be obtained. The porosity thereof is more preferably in a range of from 40 to 60%.

—Inorganic Filler—

The heat-resistant porous layer in the present invention preferably includes at least one inorganic filler. The inorganic filler is not particularly limited. Specific examples of the inorganic filler includes metal oxides such as alumina, titania, silica, and zirconia, metal carboxylates such as calcium carbonate, metal phosphates such as calcium phosphate, metal hydroxides such as aluminium hydroxide and magnesium hydroxide, and the like. Such inorganic fillers are preferably highly crystalline, from the viewpoint of the elution of impurities and durability.

Above all, the inorganic filler is preferably one that causes endothermic reaction at a temperature of from 200 to 400° C. The inorganic filler having such characteristics is not particularly limited, and examples of the inorganic filler include inorganic fillers composed of metal hydroxides, boron salt compounds, clay minerals, or the like and causing endothermic reaction at temperatures ranging from 200 to 400° C. Specific examples thereof include aluminium hydroxide, magnesium hydroxide, calcium aluminate, dawsonite, zinc borate, and the like. These may be used alone or in combination of two or more thereof. In addition, these flame-retardant inorganic fillers may be used by arbitrarily mixing with any other inorganic filler(s), for example, a metal oxide such as alumina, zirconia, silica, magnesia, or titania, a metal nitride, a metal carbide, or a metal carbonate.

Herein, for a non-aqueous electrolyte battery, particularly for a non-aqueous electrolyte secondary battery, it is thought that heat generation due to decomposition of positive electrode is the most dangerous. The decomposition occurs at around 300° C. Therefore, when the occurrence temperature of endothermic reaction is in the range of from 200 to 400° C., it is effective from viewpoint of preventing heat generation of battery. For example, aluminium hydroxide, dawsonite, and calcium aluminate cause dehydration reaction in a range of from 200 to 300° C., and magnesium hydroxide and zinc borate cause dehydration reaction in a range of from 300 to 400° C. Accordingly, it is preferable to use at least one of these inorganic fillers.

Particularly, a preferable embodiment is to use, as the inorganic filler, a metal hydroxide from the viewpoint of flame retardancy, handling ability, an electricity removal effect, an effect of improving battery durability, and the like, and above all, a preferable inorganic filler is aluminium hydroxide or magnesium hydroxide.

The inorganic filler has an average particle size ranging preferably from 0.1 to 2 μm from the viewpoint of short circuit resistance under high temperature, moldability, and the like.

The concentration of an inorganic filler in the heat-resistant porous layer is preferably from 50 to 95% by mass from the viewpoint of an effect of improving heat resistance, permeability, and handling ability.

When the heat-resistant porous layer is in the form of a microporous membrane, the inorganic filler included in the heat-resistant porous layer is present in a state of being captured by a heat-resistant resin. In the case of the heat-resistant porous layer composed of nonwoven cloth or the like, it is only necessary for the inorganic filler to be present in the constituent fiber or immobilized onto the surface of the nonwoven cloth or the like by a binder such as a resin.

˜Method for Producing Heat-Resistant Porous Layer˜

A method for producing the separator for a non-aqueous electrolyte battery of the present invention is not particularly limited as long as the method can produce the separator of the present invention formed as described above. The heat-resistant porous layer can be produced, for example, through the following steps (1) to (5).

(1) Preparation of Slurry for Coating

A heat-resistant resin is dissolved in a solvent to prepare slurry for coating. The solvent can be any as long as the heat-resistant resin can be dissolved and is not particularly limited, but specifically, a polar solvent is preferable. Examples of the polar solvent include N-methyl pyrrolidone, dimethylacetoamide, dimethylformamide, dimethylsulfoxide, and the like. In addition to these polar solvents, a solvent acting as a poor solvent for the heat-resistant resin can be also added as the solvent. Using such a poor solvent induces a microphase separation structure, thereby makes porosity easy when forming the heat-resistant porous layer. As the poor solvent, alcohols are suitable, and particularly, a polyalcohol such as glycol is suitable. The concentration of the heat-resistant resin in the slurry for coating is preferably from 4 to 9% by mass. In addition, according to need, an inorganic filler is dispersed therein to prepare a slurry for coating. When dispersing the inorganic filler in the slurry for coating, if dispersibility of the inorganic filler is insufficient, it is possible to use a technique that improves the dispersibility by performing surface-treatment of the inorganic filler with a silane coupling agent or the like.

(2) Coating of Slurry

Slurry is coated on at least one surface of the polyolefin porous base material. When the heat-resistant porous layer is formed on both surfaces of the polyolefin porous base material, the slurry is preferably simultaneously coated on both surfaces of the base material in terms of shortening the process. Examples of a method for coating a slurry for coating include a knife coater method, a gravure coater method, a screen printing method, a Meyer bar method, a die coater method, a reverse roll coater method, an inkjet method, a spray method, a roll coater method, and the like. Among them, in terms of forming a coating membrane uniformly, the reverse roll coater method is suitable. When slurry is simultaneously coated on both surfaces of the polyolefin porous base material, the coating can be performed, for example, by allowing the polyolefin porous base material to pass through between a pair of Meyer bars. Examples of the method of this case include a method performing precision measurement by coating an excessive amount of slurry for coating on both surfaces of the porous base material and allowing the coated base material to pass through between a pair of reverse roll coaters so as to scrape off excess slurry.

(3) Coagulation of Slurry

The base material coated with slurry is treated with a coagulation liquid that can coagulate the heat-resistant resin, whereby the heat-resistant resin is coagulated to form a heat-resistant porous layer composed of the heat-resistant resin. Examples of a method treating with a coagulation liquid include spraying of a coagulation liquid to a base material coated with slurry for coating, immersion of the base material in a bath containing a coagulation liquid (a coagulation bath), and the like. Herein, when setting up the coagulation bath, it is preferable to set up the bath under a coater. The coagulation liquid is not particularly limited as long as the liquid can coagulate the heat-resistant resin. Preferred is water or a mixture of a solvent used for slurry and an appropriate amount of water. Herein, the amount of water to be mixed is suitably from 40 to 80% by mass with respect to coagulation liquid. An amount of water of 40% by mass or more can further shorten a time necessary for coagulating the heat-resistant resin, allowing favorable coagulation. Accordingly, stress and elasticity at a proof stress point can be adjusted within such a range so as not to be excessively large. Additionally, when the amount of water is 80% by mass or less, coagulation of the surface of the heat-resistant resin layer contacting with coagulation liquid is not excessively rapid, which makes the surface thereof favorably porous, allowing crystallization to moderately proceed. Thus, the heat-resistant porous layer can maintain strength and can keep high stress and elasticity at the proof stress point. Furthermore, solvent recovery cost can be suppressed down.

(4) Removal of Coagulation Liquid

Coagulation liquid is removed by washing with water.

(5) Drying

Sheet is dried to remove water. The drying method is not particularly limited. Drying temperature is suitably from 50 to 80° C. When a high drying temperature is used, drying is performed preferably by contacting the sheet with a roll so as to prevent dimensional changes due to thermal shrinkage.

(6) Post-Treatment

After drying, the separator with the heat-resistant porous layer formed on the porous base material is wound up around a roll. Next, the separator in the wound-up state is subjected to heating treatment. A temperature range of the heating treatment is preferably a temperature region of from 50 to 80° C., for example. The heating treatment allows the crystallinity control of the heat-resistant resin and polyolefin.

[Non-Aqueous Electrolyte Battery]

The non-aqueous electrolyte battery of the present invention includes a positive electrode, a negative electrode, and the separator for a non-aqueous electrolyte battery of the present invention arranged between the positive electrode and the negative electrode and having the structure described above. In addition, the non-aqueous electrolyte battery of the present invention is configured to obtain electromotive force by doping and dedoping of lithium.

Examples of such a non-aqueous electrolyte battery include non-aqueous primary batteries such as a lithium-ion primary battery and non-aqueous secondary batteries obtaining electromotive force by doping and dedoping of lithium, such as a lithium-ion secondary battery and a polymer secondary battery. The non-aqueous electrolyte battery has a structure in which a multilayer structure including the negative electrode, the positive electrode, and the separator impregnated with an electrolyte and arranged between the positive electrode and the negative electrode is enclosed in an outer packaging.

The negative electrode has a structure in which a negative electrode mixture composed of a negative-electrode active material, an auxiliary conductive agent and a binder is formed on a collecting body. Examples of the negative electrode active substance include materials enabling electrochemical doping of lithium, such as carbon materials, silicon, aluminum, tin, Wood's alloy, and the like. Particularly, from the viewpoint of taking advantage of the effect of preventing liquid depletion due to the separator for a non-aqueous electrolyte battery of the present invention, it is preferable to use a negative electrode active substance having a volume change rate of 3% or more in a lithium dedoping process. Examples of such a negative electrode active substance include Sn, SnSb, Ag₃Sn, artificial graphite, graphite, Si, SiO, V₅O₄, and the like. Examples of the conductive additive include carbon materials such as acetylene black and Ketjenblack. The binder is composed of an organic high polymer, such as polyvinylidene fluoride or carboxymethylcellulose. Examples of the current collector that can be used include copper foil, stainless steel foil, nickel foil, and the like.

The positive electrode has a structure in which a positive electrode mix composed of a positive-electrode active material, an auxiliary conductive agent and a binder is formed on a collecting body. Examples of the positive-electrode active material include lithium-containing transition metal oxides, such as LiCoO₂, LiNiO₂, LiMn_{0.5}Ni_{0.5}O₂, LiCo_{1/3}Ni_{1/3}Mn_{1/3}O₂, LiMn₂O₄, LiFePO₄, LiCo_{0.5}Ni_{0.5}O₂ and LiAl_{0.25}Ni_{0.75}O₂. In particular, from the viewpoint of taking advantage of the effect of preventing liquid depletion due to the separator for a non-aqueous electrolyte battery of the present invention, as the positive-electrode active material, those having a volume change of 1% or higher during the process of dedoping lithium are preferably used. Examples of such a positive-electrode active material include LiMn₂O₄, LiCoO₂, LiNiO₂, LiCo_{0.5}Ni_{0.5}O₂ and LiAl_{0.25}Ni_{0.75}O₂. Examples of auxiliary conductive agent include carbon materials such as acetylene black and Ketjenblack. The binder is composed of an organic polymer such as polyvinylidene fluoride. Examples of the collecting body can include aluminum foil, stainless foil and titanium foil, and the like.

The electrolyte has a constitution in which a lithium salt is dissolved in a non-aqueous solvent. Examples of the lithium salt include LiPF₆, LiBF₄ and LiClO₄. Examples of the non-aqueous solvent include propylenecarbonate, ethylene carbonate, dimethylcarbonate, diethylcarbonate, ethylmethylcarbonate, γ-butyrolactone and vinylene carbonate. These may be used alone or mixed to be used.

Examples of the outer package include a metal can or aluminum laminated packaging. Examples of the shape of battery include square shape, cylinder shape and coin shape, and the separator for a non-aqueous electrolyte battery of the present invention can suitably apply any of these shapes.

The followings are descriptions of preferable embodiments of the separator for a non-aqueous electrolyte battery of the present invention and the non-aqueous electrolyte battery of the invention.

<1> A separator for a non-aqueous electrolyte battery, the separator includes a porous base material including a polyolefin and a heat-resistant porous layer provided on at least one surface of the porous base material and including a heat-resistant resin, in which when a thermomechanical analysis measurement has been performed by applying a constant load and increasing temperature at a rate of 10° C./min, the separator for a non-aqueous electrolyte battery satisfies the following conditions (i) and (ii):

(i) at least one shrinkage peak appears in a temperature range of from 130 to 155° C. in a displacement waveform representing shrinkage displacement with respect to temperature; and

(ii) an extension rate in a range of from a shrinkage peak appearance temperature T¹ to (T¹+20)° C. is less than 0.5%/° C.

<2> The separator for a non-aqueous electrolyte battery as described in the above <1>, in which when the thermomechanical analysis measurement has been performed, the porous base material has at least two shrinkage peaks in the temperature range of from 130 to 155° C. in the displacement waveform representing shrinkage displacement with respect to temperature.

<3> The separator for a non-aqueous electrolyte battery as described in the above <1> or <2>, in which the porous base material has a plurality of shrinkage peaks, and an extension rate, in a range of from an appearance temperature of a shrinkage peak having the lowest appearance temperature among the plurality of shrinkage peaks to 200° C., is 0.5%/° C. or less.

<4> The separator for a non-aqueous electrolyte battery as described in any one of the above <1> to <3>, in which in at least one shrinkage peak, a shrinkage displacement amount at a maximum displacement point is from 1 to 10% with respect to a non-shrunken state.

<5> A non-aqueous electrolyte battery including a positive electrode, a negative electrode, and the separator for a non-aqueous electrolyte battery as described in any one of the above <1> to <4> arranged between the positive electrode and the negative electrode, the non-aqueous electrolyte battery obtaining electromotive force by doping and dedoping of lithium.

### EXAMPLES

Hereinbelow, the present invention will be described in more detail with reference to Examples. It should be understood that the present invention is not limited thereto within the scope thereof. In addition, “parts” is based on mass, unless otherwise specified.

[Measurement Methods]

Individual values in the present Examples were obtained according to the following methods.

### (1) Thermomechanical Analysis Measurement (TMA)

Using a thermomechanical analyzer TMA 2940 V2.4E manufactured by TA Instruments Co., Ltd., a constant load of 0.02 N/mm was applied to a sample having a sample width of 4 mm and a sample length 12.5 mm cut out in an MD direction from a produced separator and, in a region ranging from 30 to 250° C., sample temperature was increased at a rate of 10° C./minute to follow changes in the sample length. The measurement on the sample was performed until extension reached 14% of 12.5 mm at maximum.

(2) Molecular Weight of Polyolefin

The weight average molecular weight and the number average molecular weight of polyolefin were measured by gel permeation chromatography (GPC).

To 15 mg of a sample was added 20 ml of a mobile phase for GPC measurement, and the sample was completely dissolved at 145° C. The resulting product was filtered through a stainless steel sintered filter (pore diameter: 1.0 μm). Next, 400 μl of the filtrate was injected into the apparatus for measurement to obtain a weight average molecular weight and a number average molecular weight of the sample.
Apparatus: gel permeation chromatograph ALLIANCE GPC 2000 (manufactured by Waters)
Column: TSKgel GMH6-HT×2+TSKgel GMH6-HT×2 (manufactured by Tosoh Corporation)
Column temperature: 140° C.
Mobile phase: o-dichlorobenzene
Detector: Differential refractive index detector (RI)
Molecular weight calibration: monodisperse polystyrene (manufactured by Tosoh Corporation)

(3) Membrane Thickness

The thickness of the non-aqueous electrolyte secondary battery separator (a total thickness of a polyolefin microporous membrane and a heat-resistant porous layer) and a thickness of the polyolefin microporous membrane, and a thickness of the heat-resistant porous layer, respectively, were obtained by measuring at 20 points by a contact membrane thickness gauge (manufactured by Mitutoyo Corporation) and the membrane thicknesses were measured by averaging the measurement values. Here, in the thickness measurement, a cylindrical contact probe having a bottom diameter of 0.5 cm is used.

(4) Porosity

Porosities of the non-aqueous electrolyte secondary battery separator, a polyolefin microporous membrane, and the heat-resistant porous layer were obtained by the following formula:

ε={1−Ws/(ds·t)}×100

In the formula, c represents porosity (%), Ws represents Unit weight (g/m²), ds represents true density (g/cm³), and t represents membrane thickness (μm).

(5) Gurley Value (Air Permeability)

The gurley value of the non-aqueous electrolyte secondary battery separator was obtained according to JIS P8117.

(6) Membrane Resistance

Membrane resistance was obtained by the following method.

From a membrane for sample, a sample is cut out into a size of 2.6 cm×2.0 cm. The cut-out sample is immersed in a methanol solution (methanol: manufactured by Wako Pure Chemical Industries Ltd.) containing 3% by mass of a nonionic surfactant (EMULGEN 210P manufactured by Kao Corporation), and air-dried. An aluminum foil having a thickness of 20 μm is cut out into 2.0 cm×1.4 cm, and a lead tab is attached thereto. Two sheets of the aluminium foil are prepared and the cut-out sample is sandwiched between the aluminium foils so that the aluminium foils are not short-circuited. The sample is impregnated with an electrolyte (manufactured by Kishida Chemical Co. Ltd.,) prepared by adding a mixed solvent of propylene carbonate (PC)/ethylene carbonate (EC) (PC/EC=1/1 [mass ratio]) to 1M LiBF₄. The resulting product is enclosed with reduced pressure in an aluminium laminate packaging in such a manner that the tab is outside the aluminium packaging. Cells thus formed are each produced such that one, two, or three sheets of separators are arranged in the aluminium foils. The cell is placed in a thermostat bath set at 20° C. to measure the resistance of the cell at an amplitude of 10 mV and a frequency of 100 kHz using an alternating current impedance method. The resistance value of the cell measured is plotted with respect to the number of the separators and the plots are approximated by a straight line to obtain an inclination. The inclination is multiplied by the electrode area of 2.0 cm×1.4 cm to obtain a membrane resistance (ohm-cm²) per separator.

(7) Penetration Strength

Regarding penetration strength, using a handy compression tester KES-G5 manufactured by Kato Tech Co., Ltd., puncture test was performed under conditions of a radius of curvature at the needle tip of 0.5 mm and a penetration speed of 2 mm/sec, and a maximum penetration load was defined as penetration strength. A sample was, together with a silicone rubber packing, placed and immobilized in a metal frame (sample holder) with a hole having a diameter of 11.3 mm.

(8) Heat Shrinkage Ratio

Heat shrinkage ratio was measured by heating a sample at 105° C. for 1 hour in a MD direction and a TD direction, respectively, of the sample and then averaging the resulting values.

(9) Heat Resistance (Nail Penetration Test)

Non-aqueous secondary batteries produced in Examples and Comparative Examples were charged at 0.2 C to 4.2 V for 12 hours to be in a fully charged state. Then, an iron nail with a diameter of 2.5 mm was allowed to penetrate through each charged battery. As a result, evaluation was made in which cases with ignition observed were defined as “B” and those without ignition observed were defined as “A”. The evaluation was made by producing respective 10 sample pieces of each battery to count the number of batteries determined as “B” among the 10 pieces.

(10) Shutdown Temperature

Shutdown temperature (SD temperature) was measured by the following method.

A round sample with a diameter of 19 mm was punched out of a polyolefin microporous membrane having a polymetaphenylene isophthalamide layer on both surfaces thereof. The obtained sample was immersed in a methanol solution (methanol: manufactured by Wako Pure Chemical Industries Ltd.) containing 3% by mass of a nonionic surfactant (EMULGEN 210P manufactured by Kao Corporation), and air-dried. The sample was sandwiched between two round stainless steel plates (SUS plates) with a diameter of 15.5 mm used as electrode plates in such a manner that the center of the sample was coincident with the centers thereof. Next, the sample was impregnated with an electrolyte (manufactured by Kishida Chemical Co. Ltd.) prepared by adding a mixed solvent of propylene carbonate (PC) and ethylene carbonate (EC) (PC/EC=1/1 [mass ratio]) to 1M LiBF₄. The resulting product was enclosed in a 2032-type coin cell. A lead wire was connected to the coin cell, to which a thermocouple was attached and then the coin cell was placed in an oven. The temperature of the oven was increased at a temperature increase rate of 1.6° C./minute and at the same time, the resistance of the cell was measured by an alternating current impedance method (amplitude: 10 mV, frequency: 100 kHz). Temperatures at resistance values of 10³ ohm-cm² or more were defined as shutdown temperatures.

(11) Cycling Characteristics of Charging and Discharging

A positive electrode agent paste was prepared using 89.5 parts of lithium cobaltate (LiCoO₂, manufactured by Nippon Chemical Industrial Co., Ltd.) powder, 4.5 parts of acetylene black, and 6% by mass N-methyl-2-pyrrolidone (NMP, hereinafter the same shall apply) solution of polyvinylidene fluoride (PVdF, hereinafter the same shall apply) in an amount such that PVdF was 6 parts by dry mass. The obtained paste was coated on an aluminium foil with a thickness of 20 μm, then dried and pressed to obtain a positive electrode with a thickness of 97 μm.

Next, a negative electrode agent paste was produced using 87 parts of meso-phase carbon microbeads (MCMB, manufactured by Osaka Gas Chemicals Co., Ltd.) powder, 3 parts of acetylene black, and 6% by mass N-methyl-2-pyrrolidone solution of PVdF in an amount such that PVdF was 6 parts by dry mass. The obtained paste was coated on a copper foil with a thickness of 18 μm, then dried and pressed to obtain a negative electrode with a thickness of 90 μm.

Between the positive electrode and the negative electrode obtained above was sandwiched a separator produced in each of the following Examples or Comparative Examples, and the resultant was impregnated with an electrolyte to produce 10 button batteries (CR 2032) having an initial capacity of approximately 4.5 mAh. In this case, the electrolyte used was one prepared by adding a mixed solvent of ethylene carbonate (EC), dimethyl carbonate (DMC), and methyl ethyl carbonate (MEC) (EC/DEC/MEC=1/2/1 [mass ratio]) to 1 M LiBF₄.

The produced button batteries were subjected to 100 cycles each cycle consisting of charging and discharging at a charge voltage 4.2 V and a discharge voltage of 2.75 V. A discharge capacity at the 100th cycle was divided by an initial capacity to obtain an average value of capacity conservation ratios obtained in the repetition of charging and discharging. The obtained value was defined as an index for evaluating cycling characteristics.

The cycling characteristics were evaluated according to the following evaluation criteria:

A: Capacity conservation ratio was 90% or more.
B: Capacity conservation ratio was from 85% to less than 90%, which was a range without any problem in practical use for each.
C: Capacity conservation ratio was from 75% to less than 85%, which was a range causing problems in practical use.
D: Capacity conservation ratio was less than 75%.

<Synthesis of Polyethylene>

### (PE-1)

### ˜Preparation of Solid Catalyst Component˜

In a round-bottomed flask with a capacity of 21 (litter, hereinafter the same shall apply) sufficiently substituted with nitrogen gas and equipped with a stirrer were placed 100 g of diethoxy magnesium and 130 ml of titanium tetraisopropoxide to prepare a suspension. The suspension was stirred at 130° C. for 6 hours. Next, the resulting solution was cooled down to 90° C., and then 800 ml of toluene pre-heated to 90° C. was added. The mixture solution was stirred for 1 hour to obtain a uniform solution, and 90 ml of the solution was added, in 1 hour, to 150 ml of n-heptane and 50 ml of silicon tetrachloride set to 0° C. placed in a 500-ml round-bottomed flask equipped with a stirrer. The addition was performed by stirring at a stirring count of 500 rpm while maintaining the temperature inside the system at 0° C. After that, the temperature was increased to 55° C. in 1 hour and the mixture solution was allowed to react for 1 hour to obtain a solid composition of white microparticles. Then, after removing the supernatant fluid, 40 ml of toluene was added to make into a slurry. In the slurry was added, by stirring, 20 ml of titanium tetrachloride set at room temperature in which 0.5 g of sorbitan distearate had been dissolved in advance, and additionally, 1.5 ml of di-n-butylphthalate was added thereto. Following that, the temperature of the mixture was increased to 110° C. in 3 hours to perform treatment for 2 hours. Lastly, the resulting product was washed 7 times with 100 ml of n-heptane at room temperature to obtain approximately 10 g of a solid catalyst component.

### ˜Polymerization˜

In a stainless steel autoclave with an inner volume of 1500 ml equipped with a stirrer and completely substituted with ethylene gas was placed 700 ml of n-heptane, and, while maintaining at 20° C. under the ethylene gas atmosphere, 0.70 mmol of triethyl aluminium was placed therein. Next, after increasing the temperature to 70° C., the above solid catalyst component was placed in an amount of 0.006 mmol in terms of titanium atom. While supplying ethylene such that pressure inside the system became 5 kg/cm².G, polymerization was performed for 10 hours. After filtration, the resulting product was dried under reduced pressure to obtain polyethylene powder (PE-1). The obtained polymer had a weight average molecular weight (Mw) of 6,000,000 or more.

(PE-2)

Polyethylene powder (PE-2) was obtained in the same manner as in the PE-1 except that, in the synthetic example of PE-1, the amount of the solid catalyst component added was changed from 0.006 mmol to 0.0052 mmol in terms of titanium atom, the pressure inside the system was set to 3.8 kg/cm².G, and polymerization time was 3 hours. The obtained polymer had a weight average molecular weight (Mw) of 2,040,000.

(PE-3)

1.0% by mass of chromium trioxide was supported on silica (grade 952, manufactured by W.R. Grace and Company), and the resulting product was burned at 800° C. to obtain a solid catalyst. The solid catalyst was placed in a polymerizer (reaction volume: 170 L) and additionally, an organic aluminium compound obtained by reacting methanol with aluminium trihexyl in a mole ratio of 0.92:1 was fed therein at a rate of 0.7 g/hr such that the concentration of the compound in the polymerizer became 0.08 mmol/l. Next, purified hexane was fed in the polymerizer at a rate of 60 L/hr, ethylene was fed at a rate of 12 kg/hr, and hydrogen as a molecular weight adjuster was fed such that the gas phase concentration became 2.5 mol % to perform polymerization. A polymer in the polymerizer was obtained as pellets through drying and granulating. The obtained polymer (PE-3) had a weight average molecular weight (Mw) of 420,000.

(PE-4)

Polyethylene powder (PE-4) was obtained in the same manner as in the PE-1 except that in the synthetic example of PE-1, the amount of the solid catalyst component added was changed from 0.006 mmol to 0.0048 mmol in terms of titanium atom, the pressure inside the system was set to 4 kg/cm².G, and polymerization time was 1.5 hours. The obtained polymer had a weight average molecular weight (Mw) of 810,000.

(PE-5)

Polyethylene (PE-5) was obtained in the same manner as in the PE-3 except that in the synthetic example of PE-3, the gas phase concentration of hydrogen was adjusted to be 2.8 mol %. The obtained polymer had a weight average molecular weight (Mw) of 290,000.

<Production of Polyolefin Microporous Base Material>

### (PE Membrane-1)

PE-1, PE-2, and PE-3 were mixed together in a ratio of 3.3/46.7/50.0 (parts by mass). The resulting polyethylene mixture was subjected to GPC analysis to investigate a molecular weight distribution. Table 1 shows the results.

The polyethylene mixture was dissolved in a mixed solvent of liquid paraffin (SMOIL P-350P, manufactured by Matsumura Oil Co. Ltd., boiling point: 480° C.) and decalin such that the polyethylene concentration became 30% by mass to prepare a polyethylene solution. The composition of the polyethylene solution was polyethylene: liquid paraffin: decalin=30:45:25 (mass ratio).

The polyethylene solution was extruded at 148° C. from a die and cooled in a water bath to produce a gel tape (base tape). The base tape was dried at 60° C. for 8 minutes and 95° C. for 15 minutes. Next, the base tape was stretched by twin shaft stretching that sequentially performed longitudinal stretching and transverse stretching. After the transverse stretching, thermal immobilization was performed at 125° C. to obtain a sheet. Herein, in the longitudinal stretching, stretching magnification was 5.5 times and stretching temperature was 90° C., whereas in the transverse stretching, stretching magnification was 11.0 times and stretching temperature was 105° C.

Next, the sheet obtained above was immersed in a methylene chloride bath to extract the liquid paraffin and decalin. After that, the resulting product was dried at 50° C. and subjected to annealing treatment at 120° C. to obtain a polyolefin microporous base material (PE membrane 1). No stretching unevenness was observed.

(PE membrane 2 and Comparative PE membranes 1 to 4)

A PE membrane 2 and Comparative PE membranes 1 to 4 as polyolefin microporous base materials were obtained in the same manner as in the PE membrane 1 except that the mixing ratios and stretching magnifications (longitudinal stretching×transverse stretching) of PE-1 to PE-5 were changed as shown in Table 1. Regarding the PE membrane 2 and the Comparative PE membranes 1 to 4, no stretching unevenness was observed.

TABLE 1

| | | PE | PE | Comp. PE | Comp. PE | Comp. PE | Comp. PE |
|---|---|---|---|---|---|---|---|
| | | membrane 1 | membrane 2 | membrane 1 | membrane 2 | membrane 3 | membrane 4 |
| PE-1 (Mw: | (% by | 3.3 | 9.5 | 0.2 | 0.2 | 10.0 | 5.0 |
| 6,000,000 or | mass) | | | | | | |
| more) | | | | | | | |
| PE-2 (Mw: | (% by | 46.7 | 42.3 | 23.0 | 25.0 | 41.0 | 58.0 |
| 2,040,000 | mass) | | | | | | |
| PE-3 (Mw: | (% by | 50.0 | 48.2 | 65.0 | 64.0 | 12.0 | 37.0 |
| 420,000) | mass) | | | | | | |
| PE-4 (Mw: | (% by | 0.0 | 0.0 | 11.8 | 10.8 | 0.0 | 0.0 |
| 810,000) | mass) | | | | | | |
| PE-5 (Mw: | (% by | 0.0 | 0.0 | 0.0 | 0.0 | 37.0 | 0.0 |
| 290,000) | mass) | | | | | | |
| Thickness | (μm) | 12 | 12 | 11.5 | 5 | 12 | 11 |
| Porosity | (%) | 40 | 40 | 36 | 30 | 36 | 40 |
| Weight | ×10⁴ | 199 | 199 | 88 | 101 | 290 | 127 |
| average | | | | | | | |
| molecular | | | | | | | |
| weight | | | | | | | |

| | | | | | | |
|---|---|---|---|---|---|---|
| Stretching | 5.5 × 11 | 7 × 9 | 5.5 × 11 | 5 × 10 | 3 × 20 | 5.5 × 11 |
| magnification | | | | | | |

<Production of Poly(metaphenylene isophthalamide)>

In 1120 ml of tetrahydrofuran was dissolved 160.5 g of isophthalic acid chloride. While stirring the mixture, a stream of a solution of 85.2 g of metaphenylene diamine dissolved in 1120 ml of tetrahydrofuran was gradually added. As the solution was gradually added thereto, a milky white cloudy solution was obtained. After continuing to stir for approximately 5 minutes, while further stirring the solution, an aqueous solution of 167.6 g of sodium carbonate and 317 g of salt dissolved in 3400 ml of water was rapidly added thereto and the mixture solution was stirred for 5 minutes. In the reaction system, viscosity increased after a few seconds and then decreased again, then a white suspension. The suspension was allowed to stand and then, a separated transparent aqueous solution layer was removed, followed by filtration to obtain 185.3 g of a white polymer as poly(metaphenylene isophthalamide) (hereinafter abbreviated as PMIA). The PMIA had a number average molecular weight of 24,000.

### Example 1

The PMIA and an inorganic filler composed of aluminium hydroxide (H-43M, manufactured by Showadenkosya, Co., Ltd.) with an average particle size of 0.8 μm were mixed together in a mass ratio of 25:75. The mixture was added to a mixed solvent of dimethylacetamide (DMAc) and tripropylene glycol (TPG) (=50:50 [mass ratio]) such that concentration of poly(metaphenylene isophthalamide) became 5.5% by mass to obtain a coating slurry.

A pair of Meyer bars (#6 bars) was arranged to oppose each other with a clearance of 20 μm therebetween. An appropriate amount of the coating slurry was placed on the Meyer bars. The polyethylene microporous membrane as the PE membrane 1 was allowed to pass through between the pair of Meyer bars to coat the coating slurry on both surfaces of the polyethylene microporous membrane. The coated membrane was immersed in a coagulation liquid having a composition of water:DMAc:TPG=50:25:25 [mass ratio] and adjusted to 40° C. Next, the resulting product was washed with water and dried.

In this manner, each separator sample was produced that had a heat-resistant porous layer including PMIA with a thickness of 3 μm formed on both surfaces (front and back surfaces) of the polyethylene microporous membrane (PE membrane 1).

Next, the obtained separator sample was wound up at a contact pressure of 3 MPa by a contact pressure roll while applying a tension of 1N/cm to a 6-inch aluminum core. The bobbin with the wound-up sample was placed in a hot-air thermostat bath to heat at 50° C. for 2 hours. The separator sample thus obtained was evaluated regarding thickness, porosity, air permeability, membrane resistance, penetration strength, heat shrinkage ratio, TMA, DSC, SD temperature, heat resistance, and cycling characteristics conservation ratio. Tables 2 and 3 below show the results.

### Examples 2 to 6 and Comparative Examples 1 to 4

Separator samples were produced in the same manner as in Example 1 except that, in Example 1, the PE membrane 1 as the polyethylene porous membrane was replaced by the PE membrane 2 or the comparative PE membranes 1 to 3, respectively; and thickness, porosity, and other items, as well as winding-up conditions and heating conditions were changed as shown in Table 2 below. The obtained separator samples were evaluated in the same manner as in Example 1. Tables 2 and 3 below show the results.

### Comparative Example 5

In Example 1, the comparative PE membrane 4 was used, as well as a coating slurry was obtained by mixing PMIA and an inorganic filler composed of α-alumina (SA-1, manufactured by Iwatani Chemical Industry Co., Ltd.) with an average particle size of 0.8 μm in a mass ratio of 30:70 and adding the mixture to a mixed solvent of dimethylacetamide (DMAc) and tripropylene glycol (TPG) (=60:40 [mass ratio]) in such an amount that the concentration of poly(metaphenylene isophthalamide) was 6% by mass.

A pair of Meyer bars (#6 bars) was arranged to oppose each other with a clearance of 30 μm therebetween. An appropriate amount of the coating slurry was placed on the Meyer bars. The polyethylene microporous membrane as the comparative PE membrane 4 was allowed to pass through between the pair of Meyer bars to coat the coating slurry on both surfaces of the polyethylene microporous membrane. The coated membrane was immersed in a coagulation liquid having a composition of water:DMAc:TPG=50:30:20 [mass ratio] and adjusted to 40° C. Next, the resulting product was washed with water and dried.

In this manner, a separator sample was produced that had a porous layer formed on both surfaces (front and back surfaces) of the polyethylene microporous membrane (PE membrane). Tables 2 and 3 below show the results.

TABLE 2

| | | | Ex. 1 | Ex. 2 | Ex. 3 | Ex. 4 | Ex. 5 | Ex. 6 |
|---|---|---|---|---|---|---|---|---|
| PE (porous | PE membrane used | | PE | PE | PE | PE | PE | PE |
| base | | | membrane 1 | membrane 1 | membrane 2 | membrane 1 | membrane 1 | membrane 1 |
| material) | Thickness | (μm) | 12 | 12 | 12 | 12 | 12 | 12 |
| | Porosity | (%) | 40 | 40 | 40 | 40 | 40 | 40 |
| | Weight average molecular | ×10⁴ | 199 | 199 | 199 | 199 | 199 | 199 |
| | weight | | | | | | | |
| Heat-resistant | Thickness | (μm) | 6 | 6 | 8 | 6 | 7 | 6 |
| porous layer | Porosity | (%) | 65 | 65 | 60 | 65 | 63 | 65 |
| | Aramid:inorganic filler | wt. ratio | 25:75 | 25:75 | 25:75 | 25:75 | 25:75 | 25:75 |
| Composite | Thickness | (μm) | 18 | 18 | 20 | 18 | 19 | 18 |
| membrane | Porosity | (%) | 48 | 48 | 48 | 48 | 48 | 48 |
| (separator) | Air permeability | (sec/100 cc) | 220 | 225 | 240 | 220 | 240 | 220 |
| | Membrane resistance | ohm-cm² | 3.1 | 3.1 | 3.2 | 3.1 | 3.3 | 3.1 |
| | Penetration strength | g | 300 | 330 | 290 | 300 | 290 | 290 |
| | Heat shrinkage | % | 3.5/1.8 | 4.0/2.1 | 3.5/1.5 | 3.6/2.0 | 3.1/1.4 | 3.3/1.5 |
| | (MD/TD) | | | | | | | |
| Wind-up | Wind-up tension | (N/cm) | 1 | 3 | 1 | 2 | 3 | 0.5 |
| | Wind-up contact pressure | (MPa) | 0.3 | 0.5 | 0.3 | 0.3 | 0.2 | 0.1 |
| Heating conditions | Heating temperature | ° C. | 50 | 50 | 50 | 45 | 55 | 55 |
| | Heating time | hour | 2 | 2 | 1 | 2 | 1 | 2 |

| | | | Comp. | Comp. | Comp. | Comp. | Comp. |
|---|---|---|---|---|---|---|---|
| | | | Ex. 1 | Ex. 2 | Ex. 3 | Ex. 4 | Ex. 5 |
| PE (porous | PE membrane used | | Comp. | Comp. | Comp. | Comp. | Comp. |
| base | | | PE | PE | PE | PE | PE |
| material) | | | membrane 1 | membrane 2 | membrane 3 | membrane 3 | membrane 4 |
| | Thickness | (μm) | 11.5 | 5 | 12 | 12 | 11 |
| | Porosity | (%) | 36 | 30 | 36 | 36 | 40 |
| | Weight average molecular | ×10⁴ | 88 | 101 | 290 | 290 | 127 |
| | weight | | | | | | |
| Heat-resistant | Thickness | (μm) | 6 | 12 | 6 | 20 | 4 |
| porous layer | Porosity | (%) | 70 | 60 | 60 | 50 | 48 |
| | Aramid:inorganic filler | wt. ratio | 25:75 | 25:75 | 25:75 | 25:75 | 30:70 |
| Composite | Thickness | (μm) | 17.5 | 18 | 18 | 32 | 15 |
| membrane | Porosity | (%) | 48 | 51 | 44 | 45 | 36 |
| (separator) | Air permeability | (sec/100 cc) | 220 | 280 | 270 | 310 | 447 |
| | Membrane resistance | ohm-cm² | 3.1 | 4.0 | 3.5 | 3.8 | 4.2 |
| | Penetration strength | g | 210 | 280 | 280 | 270 | 453 |
| | Heat shrinkage | % | 5.1/2.7 | 1.8/1.0 | 1.5/1.2 | 1.3/1.1 | 6.0/1.5 |
| | (MD/TD) | | | | | | |
| Wind-up | Wind-up tension | (N/cm) | 1 | 1 | 3 | 1 | 1 |
| | Wind-up contact pressure | (MPa) | 0.3 | 0.3 | 0.5 | 0.2 | 0.3 |
| Heating conditions | Heating temperature | ° C. | — | 50 | 55 | 55 | — |
| | Heating time | hour | — | 2 | 3 | 3 | — |

TABLE 3

| | | | | | | | | | Comp. | Comp. | Comp. | Comp. | Comp. |
|---|---|---|---|---|---|---|---|---|---|---|---|---|---|
| | | | Ex. 1 | Ex. 2 | Ex. 3 | Ex. 4 | Ex. 5 | Ex. 6 | Ex. 1 | Ex. 2 | Ex. 3 | Ex. 4 | Ex. 5 |
| Polyethylene microporous membrane | | | | | | | | | | | | | |
| TMA low temperature-side shrinkage peak | [A] | (C.°) | 135 | 150 | 137 | 140 | 135 | 135 | 135 | 135 | 155 | 155 | 153 |
| temperature | | | | | | | | | | | | | |
| TMA high temperature-side shrinkage peak | [B] | (C.°) | 150 | None | 151 | 152 | 149 | 149 | 148 | 150 | None | None | None |
| temperature | | | | | | | | | | | | | |
| Separator | | | | | | | | | | | | | |
| Shrinkage peak appearance temperature | [C] | (C.°) | 135 | 155 | 137 | 140 | 150 | 149 | 135 | No | 160 | 162 | 156 |
| | | | | | | | | | | peak | | | |
| Extension rate in a range of from shrinkage | | (%/C.°) | 0.1 | 0.3 | 0.2 | 0.4 | 0.03 | 0.45 | 0.52 | — | 0.47 | 0.1 | 0.6 |
| peak appearance temperature to a | | | | | | | | | | | | | |
| temperature by 20° C. higher than the | | | | | | | | | | | | | |
| temperature | | | | | | | | | | | | | |
| \|[C] − [E]\| | [D] | (° C.) | 44 | 31 | 73 | 20 | 60 | 19 | 19 | — | 45 | 88 | 19 |
| Temperature limit of extension of 0.5%/° C. | [E] | (° C.) | 179 | 186 | 210 | 160 | 210 | 168 | 154 | 250 | 205 | 250 | 175 |
| or less | | | | | | | | | | | | | |
| Amount of displacement of shrinkage peak | | (%) | 3 | 6 | 4 | 13 | 3 | 2 | 9 | — | 2 | 2 | 5 |

| | | | | | | | | | | | |
|---|---|---|---|---|---|---|---|---|---|---|---|
| SD temperature | 136 | 145 | 138 | 140 | 136 | 137 | 140 | Not SD | 155 | 155 | 150 |
| Heat resistance: number of × in nail penetration test | 1 | 1 | 0 | 2 | 0 | 0 | 10 | 1 | 10 | 5 | 5 |
| (n = 10) | | | | | | | | | | | |
| Cycling characteristics | B | B | A | B | A | A | C | C | C | D | C |

As shown in Table 3 above, the Examples had favorable shutdown characteristics in the appropriate temperature range, had no occurrence of short circuit, and showed good cycling characteristics conservation ratios. On the contrary, in the Comparative Examples, shutdown temperature was high or shutdown function did not work. In addition, due to poor heat resistance, the Comparative Examples were also inferior in terms of short circuit resistance, which made it difficult to ensure a favorable cycling characteristics conservation ratio.

The disclosure of Japanese Patent Application No. 2010-282016 is incorporated herein by reference in its entirety.

All documents, patent applications, and technical standards described in the present description are incorporated herein by reference to the same extent as if each individual document, patent application or technical standard were specifically and individually indicated to be incorporated by reference.

1. A separator for a non-aqueous electrolyte battery, the separator comprising a porous base material including a polyolefin and a heat-resistant porous layer provided on at least one surface of the porous base material and including a heat-resistant resin, wherein, when a thermomechanical analysis measurement has been performed by applying a constant load and increasing temperature at a rate of 10° C./min, the separator for a non-aqueous electrolyte battery satisfies the following conditions (i) and (ii):
(i) at least one shrinkage peak appears in a temperature range of from 130 to 155° C. in a displacement waveform representing shrinkage displacement with respect to temperature; and
(ii) an extension rate in a range of from a shrinkage peak appearance temperature T¹ to (T¹+20)° C. is less than 0.5%/° C.

2. The separator for a non-aqueous electrolyte battery according to claim 1, wherein, when the thermomechanical analysis measurement has been performed, the porous base material has at least two shrinkage peaks in the temperature range of from 130 to 155° C. in the displacement waveform representing shrinkage displacement with respect to temperature.

3. The separator for a non-aqueous electrolyte battery according to claim 1, wherein the porous base material has a plurality of shrinkage peaks, and an extension rate, in a range of from an appearance temperature of a shrinkage peak having the lowest appearance temperature among the plurality of shrinkage peaks to 200° C., is 0.5%/° C. or less.

4. The separator for a non-aqueous electrolyte battery according to claim 1, wherein in at least one shrinkage peak, a shrinkage displacement amount at a maximum displacement point is from 1% to 10% with respect to a non-shrunken state.

5. A non-aqueous electrolyte battery comprising a positive electrode, a negative electrode, and the separator for a non-aqueous electrolyte battery according to claim 1 arranged between the positive electrode and the negative electrode, the non-aqueous electrolyte battery obtaining electromotive force by doping and dedoping of lithium.
